(19) United States
(12) Patent Application Publication
(10) Pub. No.: US 2009/0031219 A1
(43) Pub. Date: Jan. 29, 2009

(54) ELECTRONIC DEVICE AND METHOD FOR PREVIEWING MEDIA CONTENT

(75) Inventor: Kai Soon LOY, Singapore (SG)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/782,334

(22) Filed: Jul. 24, 2007

(51) Int. Cl. G06F 3/02

(52) U.S. Cl. 715/700

(57) ABSTRACT

An electronic device (200) and a method (500) for previewing media content information in a play list to be played on the electronic device (200). The method (500) performs displaying information (510) regarding a currently playing media content in the play list that is playing on the electronic device (200) and detecting (515) sequential selection of adjacent keys (265) of a keypad (165) of the electronic device (200) within a pre-defined time. In response to the detecting (515), the method (500) performs displaying (520) adjacent media content information identifying adjacent media content that is adjacent the currently playing media content in the play list, the displaying is performed whilst the currently playing media content continues playing.

### FIELD OF THE INVENTION

The present invention relates generally to an electronic device and method previewing media content information in a play list to be played on such an electronic device.

### BACKGROUND OF THE INVENTION

Portable electronic devices such as handheld wireless communications devices (e.g. cellphones) that are easy to transport are becoming commonplace. Portable electronic devices, and electronic devices in general, sometimes have an input tablet that is typically a touch screen providing a two-way user interface which may include soft user input keys for data entry, invoking applications and menu traversing. In an alternative approach, these electronic devices may offer a keypad including a number of user input keys adjacent a non-touch sensitive screen, this keypad may have an integrated touch sensitive tablet so that user input commands, input data and cursor control can be either performed by lightly touching the keypad or alternatively actuating the input keys.

Portable electronic devices are increasingly becoming multi-function devices that can include, in addition to wireless telephony services, functions and applications commonly associated with media content such as digital music players, digital television and video players. However, increased functionality often results in more complex devices that may require navigating complex menus or pressing multiple keypad entries to activate specific functions. For example, if current media content from a play list of media content is being played on an electronic device with a limited number of input keys, there is no fast and convenient method of previewing the next or previous media content in the play list whilst continuing to play the current media content.

### BRIEF DESCRIPTION OF THE DRAWINGS

In order that the invention may be readily understood and put into practical effect, reference will now be made to an exemplary embodiment as illustrated with reference to the accompanying figures, where like reference numerals refer to identical or functionally similar elements throughout the separate views. The figures together with a detailed description below, are incorporated in and form part of the specification, and serve to further illustrate the embodiments and explain various principles and advantages, in accordance with the present invention where:

FIG. 1 is a schematic block diagram illustrating circuitry and components of an electronic device in accordance with the present invention;

FIG. 2 is an exploded view of part of an electronic device including the circuitry and components of FIG. 1;

FIG. 3 illustrates a side cross sectional view of the components of a keypad and a touch sensitive tablet of FIG. 2 when assembled into an overlaying relationship;

FIG. 4 illustrates a plan view of part of a membrane forming part of the keypad of FIG. 3; and

FIG. 5 illustrates a method for previewing media content information in a play list to be played on the electronic device of FIG. 2 in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and device components related to previewing media content to be played on an electronic device. Accordingly, the device components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or device that comprises a list of elements does not include only those elements but may include other elements not expressly listed or inherent to such a method or device. An element proceeded by “comprises . . . a” does not, without more constraints, preclude the existence of additional identical elements in the method, or device that comprises the element. Also, throughout this specification the term “key” has the broad meaning of any key, button or actuator having a dedicated, variable or programmable function that is actuatable by a user.

It will be appreciated that embodiments of the invention described herein may be comprised of one or more conventional processors and unique stored program instructions that control the one or more processors to implement, in conjunction with certain non-processor circuits, some, most, or all of the functions of character entry in an electronic device described herein. The non-processor circuits may include, but are not limited to, a radio receiver, a radio transmitter, signal drivers, clock circuits, power source circuits, and user input devices. As such, these functions may be interpreted as steps of a method to perform previewing media content to be played on an electronic device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

According to one aspect of the present invention there is provided a method for previewing media content information in a play list to be played on an electronic device, the method comprising: displaying information regarding a currently playing media content that is playing on the electronic device, the currently playing media content forming part of the play list; detecting sequential selection of adjacent keys of a keypad of the electronic device within a pre-defined time; and displaying an adjacent media content information in response to the detecting, the adjacent media content information identifying adjacent media content that is adjacent the currently playing media content in the play list and the displaying being performed whilst the currently playing media content continues the playing.

According to another aspect of the present invention there is provided an electronic device comprising: a processor; a display screen coupled to the processor; a keypad coupled to the processor; and a memory coupled to the processor, the memory storing at least part of a play list of media content, wherein in operation the display screen provides for displaying information regarding a currently playing media content that is playing on the electronic device, the currently playing media content forming part of the play list and in response to the processor detecting sequential selection of adjacent keys of a keypad within a pre-defined time the display performs displaying an adjacent media content information in response to the detecting, and wherein the adjacent media content information identifies adjacent media content that is adjacent the currently playing media content in the play list and the displaying being performed whilst the currently playing media content continues playing.

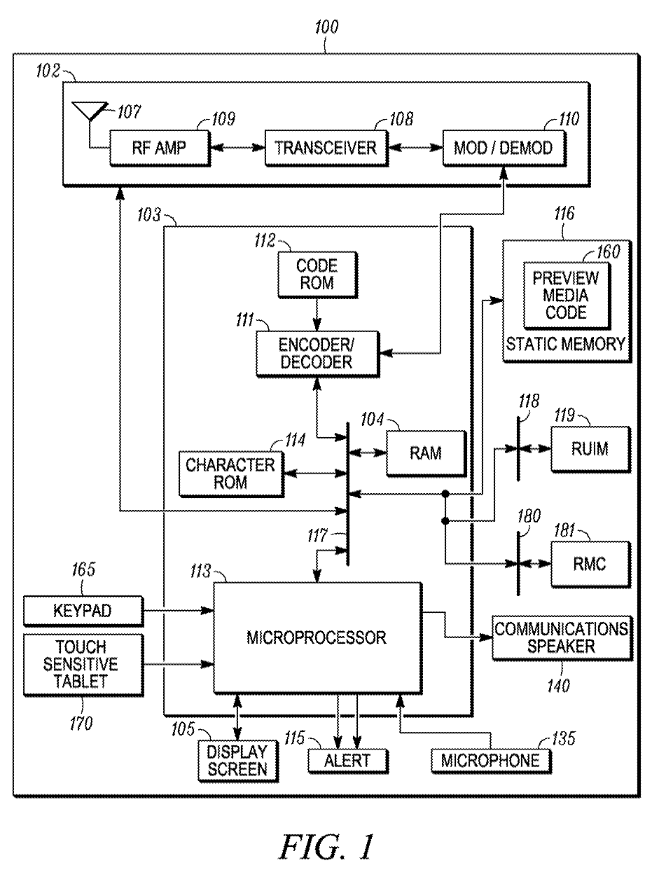

Referring to FIG. 1, there is a schematic diagram illustrating circuitry and components 100 of an electronic device, typically a wireless communications device, in the form of a mobile station or mobile telephone comprising a radio frequency communications unit 102 coupled to be in communication with a processor 103. The circuitry and components 100 includes a display screen 105 such as an LCD screen and a keypad 165. There is also an alert module 115 that typically contains an alert speaker, vibrator motor and associated drivers. The display screen 105, keypad 165 and alert module 115 are coupled to be in communication with the processor 103. The circuitry and components 100 also comprises a touch sensitive tablet 170 coupled to the processor 103.

The processor 103 includes an encoder/decoder 111 with an associated code Read Only Memory (ROM) 112 for storing data for encoding and decoding voice or other signals that may be transmitted or received by the radio frequency communications unit 102. The processor 103 also includes a microprocessor 113 coupled, by a common data and address bus 117, to the radio frequency communications unit 102, the encoder/decoder 111, a character Read Only Memory (ROM) 114 and a Random Access Memory (RAM) 104. Coupled to the microprocessor 113 by the common data and address bus 117 are: a static memory 116; an interface 118 to which is coupled a removable Secure Memory 119 which may comprise a Removable User Identity Module card (RUIM) in subscriber card based mobile phones; and an interface 180 to which is coupled a Removable Memory Card (RMC) 181 that can store media content such as music, video content graphics and any other form of media. The static programmable memory 116 and a RUIM card 119 (commonly referred to as a Subscriber Identity Module (SIM) card) each can store, amongst other things, Preferred Roaming Lists (PRLs), subscriber authentication data, selected incoming text messages and a Telephone Number Database (TND phonebook) comprising a number field for telephone numbers and a name field for identifiers associated with one of the numbers in the name field. The RUIM card 119 and static memory 116 may also store passwords for allowing accessibility to password-protected functions.

The microprocessor 113 has ports for coupling to the display screen 105, the keypad 165, the touch sensitive tablet 170, and the alert module 115. Also, the microprocessor 113 has ports for coupling to a microphone 135 and a communications speaker 140.

The character Read Only Memory 114 stores code for decoding or encoding text messages that may be received by the radio frequency communications unit 102. In this embodiment the character Read Only Memory 114, RUIM card 119, and static memory 116 may also store Operating Code (OC) for the microprocessor 113 and code for performing functions associated with the circuitry and components 100. In this embodiment the static memory 116 includes preview media code 160 for detecting specific selections on keys on the keypad 165.

The radio frequency communications unit 102 is a combined receiver and transmitter having a antenna 107. The radio frequency communications unit 102 has a transceiver 108 coupled to the antenna 107 via a radio frequency amplifier 109. The transceiver 108 is also coupled to a combined modulator/demodulator 110 that couples the radio frequency communications unit 102 to the processor 103.

The touch sensitive tablet 170 detects contact or close proximity of a user's digit (finger) and is typically integrated with the keypad 165 or the display screen 105. If the touch sensitive tablet 170 is integrated with the display screen 105 then the display screen becomes a touch screen as will be apparent to a person skilled in the art. The detected manual contact or close proximity of a user's digit or a stylus by the touch sensitive tablet 170 is interpreted by the processor 103 as points or lines of an xy co-ordinate system of the touch sensitive tablet 170. The touch sensitive tablet 170 may operate by detecting variations in capacitance or resistance and thus a force or actual contact may not necessarily need to be required in order for the touch sensitive tablet 170 to provide the xy co-ordinates. The interpretation of the detected contact or close proximity of a digit as xy co-ordinates identifying points or lines by the processor 103 will typically be implemented with the execution of program code stored in the static memory 116 as will be appreciated by those skilled in the art.

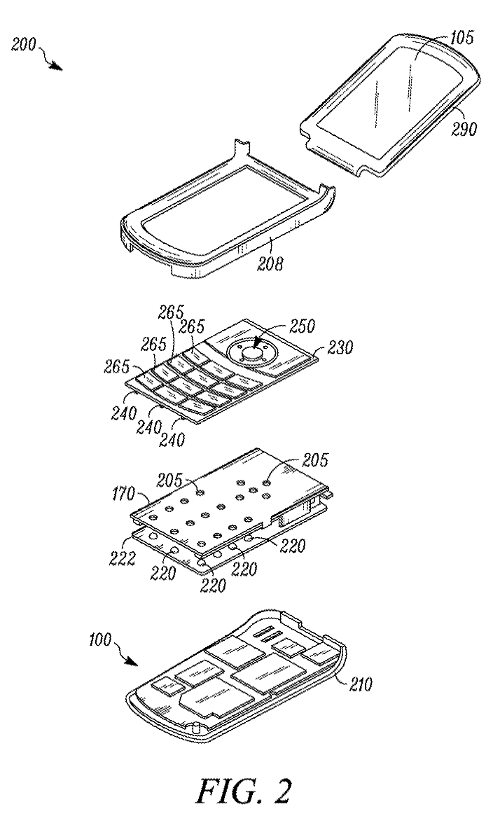

FIG. 2 is an exploded view of part of an electronic device 200 including the circuitry and components 100 and illustrates in more detail an arrangement of components of the keypad 165 and touch sensitive tablet 170 when integrated. The keypad 165 includes a membrane 230 of user input keys 265 and navigation keys 250 and a switch substrate 222 with dome switches 220 mounted thereon. The touch sensitive tablet 170 has apertures 205 for allowing respective plungers 240 of each of navigation keys 250 and the user input keys 265 to pass therethrough and actuate the dome switches 220 on the switch substrate 222. The components of the keypad 165 are integrated in an overlaying relation with the touch sensitive tablet 170 as shown.

The circuitry and components 100 are housed in a housing comprising an upper housing 208 and lower housing 210 with a pivotally mounted flip 290 that houses the display screen 105. Thus, as illustrated the electronic device 200 is a flip or clam shell device however the electronic device may take other forms such as a two part slider device or a candy bar type device.

The touch sensitive tablet 170 provides a touch sensitive user interface that allows for receiving user contact or touch points or lines of contact with the touch sensitive tablet 170. Such tablets are typically implemented using an array of capacitive sensors which detect changes in capacitance corresponding to the presence of a user's digit or other object such as a stylus. Detection of a finger or stylus therefore does not require pressure against the sensor array or touch sensitive tablet 170, but typically just a light touch or contact against the surface of the membrane 230 or even just close proximity of a finger. It is therefore possible to integrate the user input keys 265 and the touch sensitive tablet 170, as the user input keys 265 require physical pressure or a tactile force for actuation whereas the capacitive sensors of the touch sensitive tablet 170 do not. Thus it is possible to detect manual contact at the user input keys 265 or navigation keys 250 without actuating any of these user input keys 265 or navigation keys 250. An example of a touch sensitive tablet 170 is the finger writing recognition tablet on the A668 mobile phone available from Motorola Incorporated.

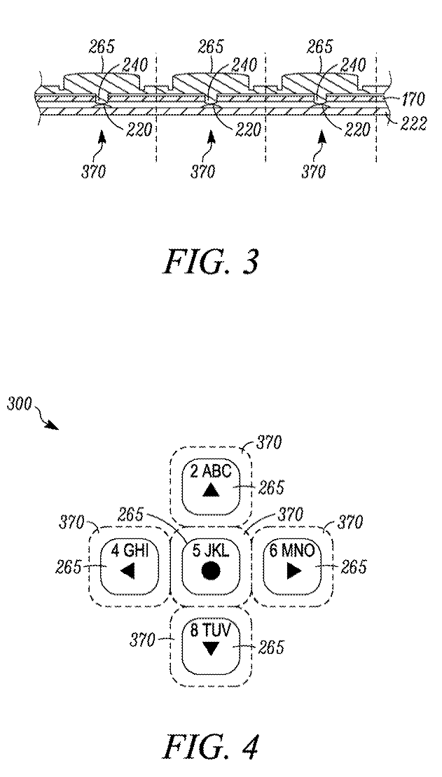

Referring to FIG. 3 there is illustrated a side cross sectional view of the components of the keypad 165 and touch sensitive tablet 170 when assembled into an overlaying relation. The plungers 240 extend through the apertures 205 of the touch sensitive tablet 170 and in use actuate the dome switches 220 in response to a force applied to the user input keys 265 or navigation keys 250 by a user. Regions 370 of the touch sensitive tablet 170 are allocated to correspond with an overlaying user input key 265 or navigation key 250 of the membrane 230. Changes in capacitance detected by the touch sensitive tablet 170 are translated into a contact location on an xy grid by the processor 103. Hence, each region 370 may be defined using predetermined ranges of xy coordinates on the xy grid of the touch sensitive tablet 170. Each region 370 and its corresponding user input key 265 (or navigation key 250) are typically co-located as shown. Thus detecting proximity of a user's digit (finger) or stylus at one of the regions corresponds to proximity of the user's finger or digit to the co-located user input key 265 or one of the navigation keys 265. Therefore manual contact at a region 370 can be used to detect manual contact at a corresponding user input key 265 or one of the navigation keys 250.

Referring to FIG. 4 there is illustrated a plan view of part of the membrane 230. Five of the user input keys 265 are shown, however it should be noted that the following also applies to the navigation keys 250. Contact at the left user input key 265 by a user's digit or stylus which is associated with the character “4”, can be detected by detecting proximity of a user digit at the corresponding region 370 surrounding this user input key 265. Similarly, contact at the right user input key 265 which is associated with the character “6”, can be detected by detecting proximity of a user digit at the corresponding region 370 surrounding this user input key 265. As a further example, contact at the middle user input key 265 which is associated with the character “5”, can be detected by detecting proximity of a user digit at the corresponding region 370 surrounding this user input key 265.

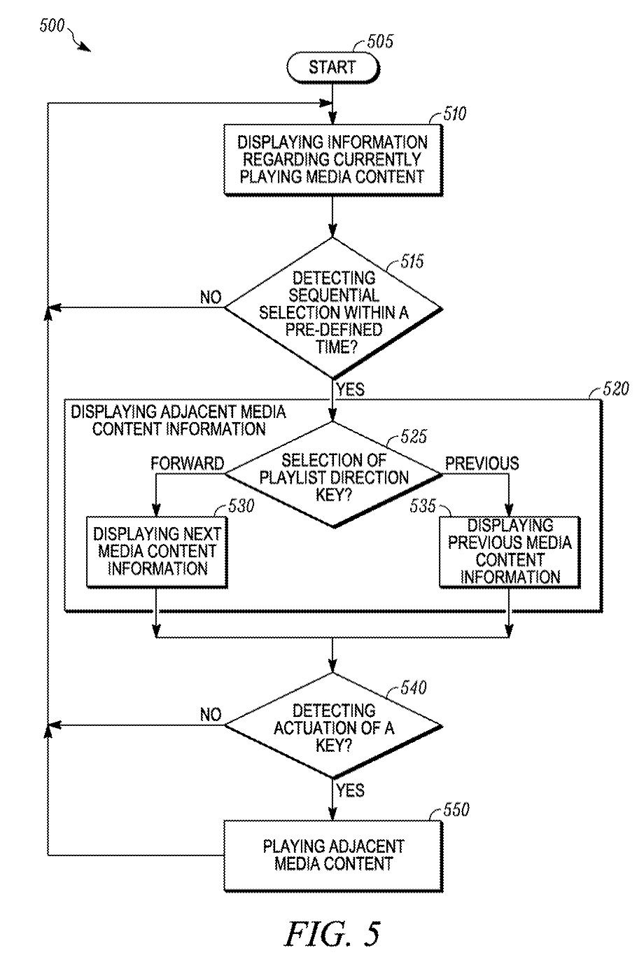

FIG. 5 illustrates a method 500 for previewing media content information in a play list PL to be played on the electronic device 200. The play list may typically be provided from media content stored on the RMC 181 or stored in the static memory 116 or transmitted over the air to the electronic device 200. Depending on the type of media content the media content may be played through the communications speaker 140, or through other designated speakers that can be integral or external to the electronic device 200 (not illustrated) and/or through the display screen 105. Also, the method 500 is controlled by the preview media code 160 stored in the static memory 116. The method 500 is typically invoked at a start block 505 by a user actuating a user input key or keys 265, for instance user input key 265 which is associated with the character “5” is actuated to request a media content such as a song (musical composition) or video to be played from a play list PL of media content that is typically at least partially stored or buffered in the static memory 116. Assuming that the nth media content of the play list PL is being played on the electronic device 200, then the method 500 performs, at a block 510, displaying information regarding the currently playing media content (the nth media content) that is playing on the electronic device 200. The displaying is effected on the display screen 105 to inform a user of information about the currently playing media content (the nth media content) forming part of the play list PL. Such information could include, but is not limited to: media content title, duration of the media content; name of the media content performer; name of the media content composer; date of media content creation; source of the media content.

After block 510 the method 500 conducts a detecting test, at a test block 515, for detecting sequential selection of adjacent keys 265 of the keypad 165 of the electronic device 200 within a pre-defined time. This pre-defined time is typically programmed to be less than two seconds and if there is no detection of the sequential selection of adjacent keys 265 the method returns to block 510 and the currently playing media content (the nth media content) continues to be displayed and played. However, if at the test block 515, the sequential selection of adjacent keys 265 within the pre-defined time is detected then at a block 520 there is performed displaying an adjacent media content information in response to the detecting. The adjacent media content information identifies adjacent media content (the n+1th or n−1th media content) that is adjacent the currently playing media content (the nth media content) in the play list PL and the displaying is performed whilst the currently playing media content continues playing. Such information again could include, but is not limited to: media content title, duration of the media content; name of the media content performer; name of the media content composer; date of media content creation; source of the media content.

It should be noted that in one embodiment the selection or detecting sequential selection of adjacent keys 265 is characterised by the selection being an actuation of the adjacent keys 265. Such actuation is typically only required when the there is no touch sensitive tablet 170 in overlaying relationship with the adjacent keys 265. However, in one alternative embodiment the selection or detecting sequential selection of adjacent keys 265 is characterised by the selection being detected by the touch sensitive tablet 170 having number of regions mapped to one of the adjacent keys 265. In this embodiment touch sensitive tablet 170 is in an overlaying relationship with the adjacent keys 265.

As shown, block 520 may be described in more detail as follows. At a test block 525 a test is conducted to determine the type of sequential selection of the adjacent keys 265, the type of sequential selection is characterised by detecting selection of a reference key followed by detection of a selection of one of two play list direction keys. The reference key is typically the input key 265 which is associated with the character “5” and the two play list direction keys are the input keys 265 associated with the characters “4” and “6”. Thus, the test at the test block 525 determines the selection of the play list direction key that can either be a forward or backward play list PL selection. If the reference key “5” followed by the forward key “6” as first one of play list direction keys were sequentially selected then the selected play list PL direction is “FORWARD” results, at a block 530, in the next adjacent media content information (for the n+1th media content) in the play list PL being displayed during the displaying of block 520.

Alternatively if the test at the test block 525 determines that the reference key “5” followed by the previous key “4” as first one of play list direction keys were sequentially selected then the selected play list PL direction is “PREVIOUS” results, at a block 535, in the previous adjacent media content information (for the n−1th media content) in the play list PL being displayed during the displaying of block 520.

After block 520 a test is performed at a detecting test block 540 to determine if there was an actuation of a user input key 265 this key being the reference key “5” or one of the play list direction keys (the previous key “4” or the forward key “6”). If there was no actuation detected at the detecting test block 540 then after a short time delay the method returns to block 510 and the currently playing media content (the nth media content) continues to be displayed and played. However, if actuation was detected at the detecting test block 540 then, at a block 550, a further step of playing the adjacent media content in response to detecting actuation of one the two play list direction keys “4” or “5”, or reference key “5” whilst the adjacent media content in the play list is being displayed during the displaying. At block 550 the adjacent media content becomes the currently playing media content and the method 500 then returns to block 510.

Advantageously, the present invention provides for a relatively fast and convenient method of previewing the next or previous media content in the play list PL, to be played on an electronic device with a limited number of input keys, whilst continuing to play the current media content. This is achieved by the electronic device 200 detecting sequential selection of adjacent keys of a keypad 165 within a pre-defined time.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims.

We claim:

1. A method for previewing media content information in a play list to be played on an electronic device, the method comprising:
displaying information regarding a currently playing media content that is playing on the electronic device, the currently playing media content forming part of the play list;
detecting sequential selection of adjacent keys of a keypad of the electronic device within a pre-defined time; and
displaying an adjacent media content information in response to the detecting, the adjacent media content information identifying adjacent media content that is adjacent the currently playing media content in the play list and the displaying being performed whilst the currently playing media content continues the playing.

2. A method for previewing media content information in a play list as claimed in claim 1, wherein the detecting sequential selection is characterised by detecting selection of a reference key followed by detection of a selection of one of two play list direction keys.

3. A method for previewing media content information in a play list as claimed in claim 2, wherein the selection of a first one of the play list direction keys results in a next adjacent media content information in the play list being displayed during the displaying.

4. A method for previewing media content information in a play list as claimed in claim 3, wherein the selection of a second one of the play list direction keys results in a previous adjacent media content information in the play list being displayed during the displaying.

5. A method for previewing media content information in a play list as claimed in claim 2, including a further step playing the adjacent media content in response to detecting actuation of one the two play list direction keys whilst the adjacent media content in the play list is being displayed during the displaying.

6. A method for previewing media content information in a play list as claimed in claim 2, including a further step playing the adjacent media content in response to detecting actuation of the reference key whilst the adjacent media content in the play list is being displayed during the displaying.

7. A method for previewing media content information in a play list as claimed in claim 1, wherein the detecting sequential selection of adjacent keys is characterised by the selection being an actuation of the adjacent keys.

8. A method for previewing media content information in a play list as claimed in claim 1, wherein the detecting sequential selection of adjacent keys is characterised by the selection being detected by a touch sensitive tablet having a number of regions mapped to one of the adjacent keys, the touch sensitive tablet being in an overlaying relationship with the adjacent keys.

9. A method for previewing media content information in a play list as claimed in claim 1, wherein the pre-defined time is less than two seconds.

10. An electronic device comprising:
a processor;
a display screen coupled to the processor;
a keypad coupled to the processor; and
a memory coupled to the processor, the memory storing at least part of a play list of media content, wherein in operation the display screen provides for displaying information regarding a currently playing media content that is playing on the electronic device, the currently playing media content forming part of the play list and in response to the processor detecting sequential selection of adjacent keys of a keypad within a pre-defined time the display performs displaying an adjacent media content information in response to the detecting, and wherein the adjacent media content information identifies adjacent media content that is adjacent the currently playing media content in the play list and the displaying being performed whilst the currently playing media content continues playing.

11. An electronic device as claimed in claim 10, wherein the detecting sequential selection is characterised by detecting selection of a reference key followed by detection of a selection of one of two play list direction keys.

12. An electronic device as claimed in claim 11, wherein the selection of a first one of the play list direction keys results in a next adjacent media content in the play list being displayed during the displaying.

13. An electronic device as claimed in claim 12, wherein the selection of a second one of the play list direction keys results in a previous adjacent media content in the play list being displayed during the displaying.

14. An electronic device as claimed in claim 11 wherein the electronic device performs playing the adjacent media content in response to detecting actuation of one the two play list direction keys whilst the adjacent media content in the play list is being displayed during the displaying.

15. An electronic device as claimed in claim 11 wherein the electronic device performs playing the adjacent media content in response to detecting actuation of one the reference key whilst the adjacent media content in the play list is being displayed during the displaying.

16. An electronic device as claimed in claim 10, wherein the detecting selection of adjacent keys is characterised by the selection being an actuation of the adjacent keys.

17. An electronic device as claimed in claim 10, wherein the keypad includes a touch sensitive tablet having a number of regions to one of the adjacent keys, the touch sensitive tablet being in an overlaying relationship with the adjacent keys.

18. An electronic device as claimed in claim 10, wherein the pre-defined time is less than two seconds.
